(19) United States
(12) Patent Application Publication
(10) Pub. No.: US 2007/0157473 A1
(43) Pub. Date: Jul. 12, 2007

(54) Retrieving Shears

(76) Inventor: Donald Varnell, Plaquemine, LA (US)

Correspondence Address: NEIL J. COIG, 2355 DRUSILLA LANE, BATON ROUGE, LA, 70809, US

(21) Appl. No.: 11/619,613

(22) Filed: Jan. 4, 2007

Related U.S. Application Data
(60) Provisional application No. 60/758,071, filed on Jan. 11, 2006.

(51) Int. Cl. B26B 13/00

(52) U.S. Cl. 30/194

(57) ABSTRACT

The present invention is an improved pruning device which is capable cutting and/or retrieving or collecting items without such items being damaged or falling on the user or out of his/her reach. Thus, items which are beyond the reach of a user may thus be easily retrieved both in high or hard to reach areas, whether by distance or hazard (thorns, uneven surfaces, irritants, etc.).

### CONTINUATION HISTORY

This application is a continuation of Provisional U.S. Patent Application 60/758,071, filed on Jan. 11, 2006, which is hereby incorporated by reference in its entirety.

### BACKGROUND OF THE INVENTION

The present invention relates to an apparatus for cutting and retrieving objects using a single simple tool.

In the traditional mode of cutting stems, flowers and the like, shears are employed to cut such items, and the user of such shears must then be diligent in catching what is cut, or risk having it fall to the ground, damaging it, or destroying it in the process. While this particular task may not be particularly difficult if the object sought to be cut is within arm's reach, objects that are far away or not readily accessible become very difficult to harvest, and damage or loss of the object sought to be retrieved from a plant or tree is likely to occur.

Similarly, items which are in precarious places, such as within thorny or poisonous foliage (e.g., roses or poison ivy) may be very difficult to reach through, over or around. Gloves and other preventative measures may be taken, but a user still must take risks when performing such tasks. In the current state of the art, there is no known device which is capable of cutting objects and retrieving them at the same time at a distance, which is what the present invention seeks to accomplish.

Obvious downsides to the current mode of retrieving exist, as outlined above, such as not being able to reach high or far branches or blooms, risking damage or injury by using ladders to reach items or reaching into thorny or poisonous foliage. The consequence of these issues is an inability or reduced ability to harvest a product. By providing this tool, however, a user may extend his or her reach to areas that were previously impossible to access, and the items sought to be retrieved can be collected without damage to the user or the item retrieved, such as delicate fruit, blooms, or the like.

All of these aspects of the current mode of utilizing shears lead to an increased need for a revised apparatus for cutting and retrieving, all of which the present invention addresses.

The present invention of a set of retrieving shears is thus a much-improved apparatus for performing the above-outlined tasks.

### OBJECTS OF THE INVENTION

One object of the invention is to provide an improved apparatus for trimming foliage.

Another object of this invention is to provide an improved apparatus for retrieving items.

Yet another object of this invention is to provide a more versatile shearing device.

Still another object of this invention is to provide a device capable of extending a user's reach.

Other objects and advantages of this invention shall become apparent from the ensuing descriptions of the invention.

### SUMMARY OF THE INVENTION

According to the present invention, a set of retrieving shears are disclosed. The shears are an improved pruning device which is capable of cutting and/or retrieving or collecting items without such items being damaged or falling on the user or out of his/her reach. Items which are beyond the reach of a user may thus be easily retrieved either in a high or hard to reach area, whether by distance or hazard (thorns, uneven surfaces, irritants, etc.).

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a right perspective view of the retrieving shears.

FIG. 2 is a left perspective view of the retrieving shears.

FIG. 3 is front view of the retrieving shears.

FIG. 4 is a perspective view of the shears holding a retrieved item from a tree or bush.

FIG. 5 is a perspective view of a user utilizing the retrieving shears with a bag attachment employed.

### DETAILED DESCRIPTION OF EXEMPLARY EMBODIMENTS

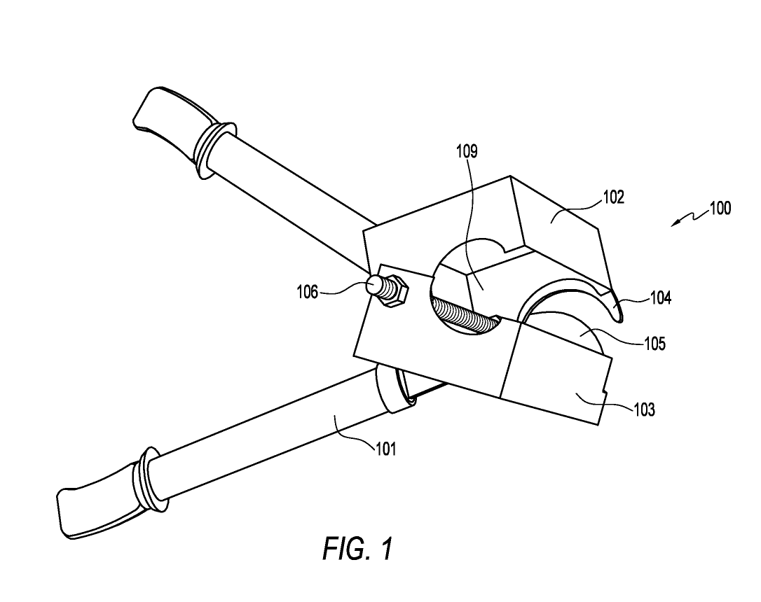

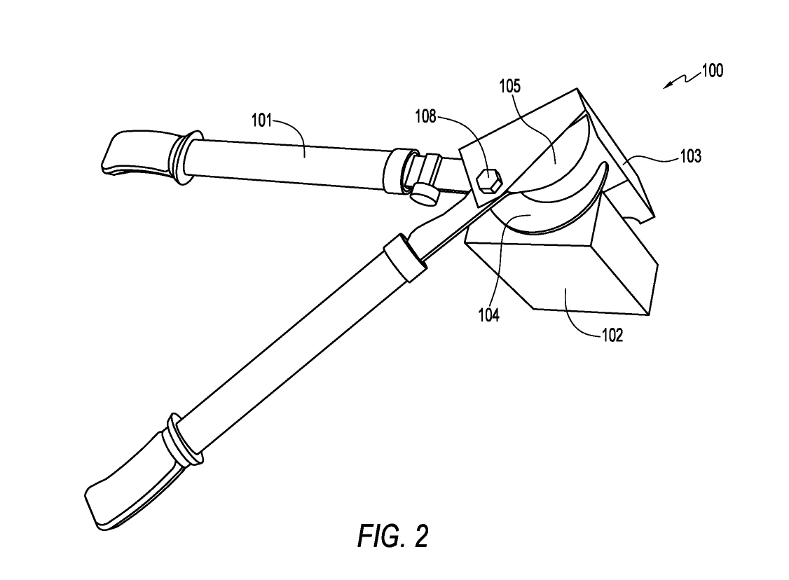

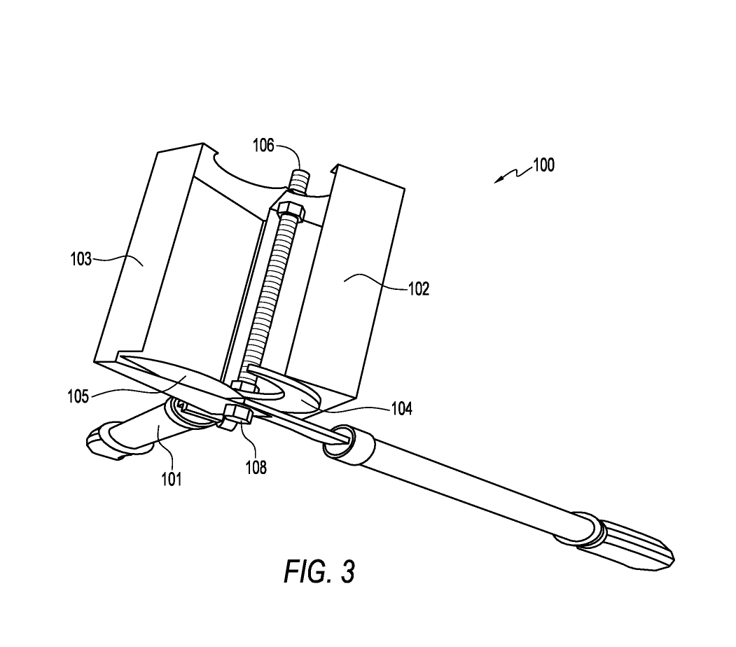

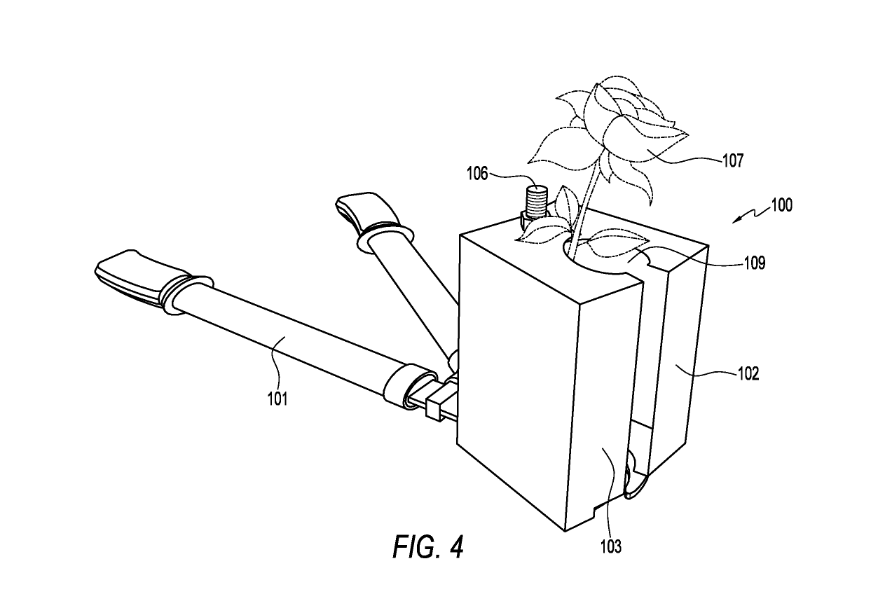

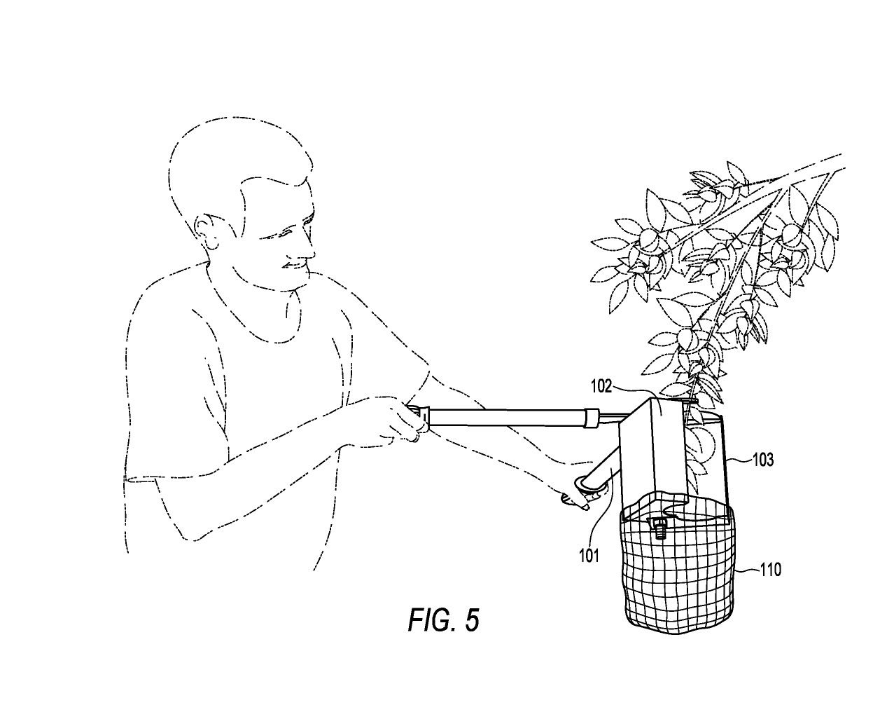

Without any intent to limit the scope of this invention, reference is made to the figures in describing the various embodiments of the invention. FIGS. 1-5 show various aspects of exemplary embodiments of the present invention.

The present invention relates to a set of retrieving shears 100, which are an improved design of pruning shears, a device which has joint member 108 coupling a first blade 104 and a second blade 105. The improved design consists of replacing the typical short joint with elongated joint member 108 which attaches together not only first blade 104 to second blade 105, but also attaches first collection compartment 102 and second collection compartment 103 to retrieving shears 100 by piercing collection compartments 102 103 as indicated in the Figures. In this way, first collection compartment 102 and second collection compartment 103 move with their respective blades 104 105.

First collection compartment 102 is in the design of a bowl or tray with a bottom and four sides, wherein the top is open. On one side of first collection compartment 102, the side is shaped to parallel the general shape of first blade 104 such that the profile of first collection compartment 102 remains substantially similar. On the opposite side of first collection compartment 102 is another side with a similar shape, but has a portion cut away to form a portion of opening 109.

Shears 100 also have second collection compartment 103 which is also in the design of a bowl or tray with a bottom and four sides, wherein the top is open. On one side of second collection compartment 103, the side is shaped to parallel the general shape of second blade 105. On the opposite side of second collection compartment 103 is another side with a similar shape, but has a portion cutaway to form an opening 109 together with the cutaway portion of first collection compartment 102. Second collection compartment 103 is also shaped to be able to be partially introduced within first collection compartment 102 to create an enclosed space therein.

In operation, then, a user will use handles 101 of shears 100 to open the blades 104 105. The fruit, flower, or other item 107 will be positioned between first collection compartment 102 and second collection compartment 103 such that it will be all or partially enclosed within the two. Handles 101 will then be closed and blades 104 105 will cut desired item 107 free, holding it within the two compartments 102 103. If item 107 is longer than the width of compartments 102 103 then the extra length may extend through opening 109.

The benefits of this device also extend beyond being able to simply catch the cut bloom, fruit, branch or the like. It can also cut thorny items that would otherwise harm a user's hands if cut without protection. Various fruits can be cut and/or harvested as well, with the fruit being stored in a receiver container, bag or other sack-like device 110 (even as simple as a Zip-Lock® type bag) which can be attached to the container to retain fruit (or other items) and keep them stored while using the shears. This can be attached in myriad ways, such as simply as using hooks placed through holes in the catching device and then hooked to receiver container 110, or with adhesives, Velcro® or any number of other methods. In this fashion, several items can be retrieved and dropped into the receiver container 110 before having to bring shears 100 in for unloading.

Items 107 can be cut without crushing or damaging the bloom or damaging the fruit or vegetable since the stem is cut while item 107 is contained within the device. Another benefit of this device is that shears 100 may be stood up on the side, a position that would be otherwise impossible without the aforementioned container being attached thereto. This makes it easier for a handicapped person, for example, to pick shears 100 up from a seated position, without having to lean over as much or at all to contact the ground. Further, the use of shears 100 with the compartments 102 103 installed can be extended to picking up other items, such as toys, paper, trash, etc.

It should be considered part of this application that a proportionate or similar-sized container could be attached to other shears of various sizes to create the same or similar benefits discussed herein. For example, small hand-held shears or even scissors could be fitted with a similar catching and retaining device for smaller objects. Scissors, likewise, could also be fitted with a similar device to accomplish a similar result. Conversely, longer handles may be employed either as an accessory or part of handles 101 themselves to further extend a user's reach. A spring can also be employed between handles 101 to aid in returning the device to the open position when released.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A pair of retrieving shears, comprising a set of shears having a joint connecting a first blade and a second blade, the improvement to which comprises:
a. an elongated joint member attaching said blades at said joint;
b. a first collection compartment comprising a tray operatively connected to said elongated member and configured to maintain operative contact with said first blade;
c. said first collection compartment further comprising a first side shaped to be substantially similar in contour to said first blade and wherein said first collection compartment has a second side opposite said first side shaped to form an opening;
d. a second collection compartment comprising a tray operatively connected to said elongated member and configured to maintain operative contact with said second blade;
e. said second collection compartment further comprising a first side shaped to be substantially similar in contour to said second blade and wherein said second collection compartment has a second side opposite said first side shaped to form an opening; and
f. wherein said second sides of said first collection compartment and said second collection compartment are operatively configured to form an opening.

2. The improvement to the retrieving shears of claim 1 wherein said shears are elongated handled shears.

3. The improvement to the retrieving shears of claim 1 wherein said shears are pruning shears.

4. The improvement to the retrieving shears of claim 1 wherein said shears are scissors.

5. The improvement to the retrieving shears of claim 1 further comprising a receiving container operatively affixed to said first collection compartment and said second collection compartment near said opening.
